(19) United States
(12) Patent Application Publication
(10) Pub. No.: US 2011/0173818 A1
(43) Pub. Date: Jul. 21, 2011

(54) CLIPPER/TRIMMER BLADE SET

(76) Inventors: Sean Lacov, Boca Raton, FL (US); Ricky Dean, Sparta, TN (US)

(21) Appl. No.: 13/119,570

(22) PCT Filed: Sep. 8, 2009
(86) PCT No.: PCT/US09/56171

§ 371 Date: Mar. 17, 2011

Related U.S. Application Data
(60) Provisional application No. 61/097,569, filed on Sep. 17, 2008.

(51) Int. Cl. B26B 19/06; B26B 19/38

(52) U.S. Cl. 30/223; 30/225

(57) ABSTRACT

A hair clipper/trimmer includes a blade set having a stationary clipper comb and a movable cutter blade. To decrease the heat transfer from the clipper comb, the clipper comb can be cooled by a convection cooling. The clipper comb can be provided with a plurality of vented sections extending through the inner and outer surfaces of the clipper comb. In this manner, when in use, air flows through the clipper comb, cooling the clipper comb. To aid in the air flow, the inner surface of the moveable cutter blade can include fins extending therefrom. In use, the fins direct the airflow through the vented section in the clipper comb.

### FIELD OF THE INVENTION

The present disclosure relates to a method and apparatus for removing heat from electric clipper blade assemblies of the type used in hair grooming.

### BACKGROUND OF THE INVENTION

A common issue with modern electric hair clippers is that the rate of reciprocation of the cutting blade is typically high enough to cause significant increases in the temperature of the clipper blade and clipper comb. Because the clipper comb is in direct contact with a person or animal being shaved, a hot comb can result in discomfort to the subject. It is not unusual for the clipper comb to reach temperatures of 100° F. or more within just 7 or 8 minutes of continuous use. Much of this is due to the friction between the reciprocating clipper cutter blade and stationary clipper comb which together form a clipper head assembly.

### SUMMARY OF THE INVENTION

The present disclosure provides an apparatus for use with hair clippers/trimmers for decreasing the amount of heat transferred to the scalp/skin of a user. A hair clipper/trimmer includes a blade set having a stationary clipper comb and a movable cutter blade. To decrease the heat transfer, the clipper comb can include a heat resistant cover affixed to an outer surface of the clipper comb, where the outer surface is adjacent to a user's skin when in use. The heat resistant cover provides a protective, insulating, barrier decreasing the amount of heat transferred from the clipper comb to the user.

In another embodiment, the clipper comb can be cooled by convection cooling. The clipper comb can be provided with a plurality of vented sections extending through the inner and outer surfaces of the clipper comb. In this manner, when in use, air flows through the vented sections of the clipper comb, cooling the clipper comb.

To aid in the air flow, the inner surface of the moveable cutter blade can include fins extending therefrom. In use, the fins direct the airflow through the vented section in the clipper comb.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a partial isometric view of a clipper blade set mounted on an electric hair clipper/trimmer;

FIG. 2 depicts an exploded view of the clipper blade set of FIG. 1;

FIG. 3 depicts a top view of a clipper comb having a heat resistant cover;

FIG. 4 depicts a side view of the clipper comb and heat resistant cover of FIG. 3;

FIG. 5 depicts an exploded view of an alternative clipper blade set with a heat resistant cover;

FIG. 6 depicts a top view of the clipper comb and heat resistant cover of FIG. 5;

FIG. 7 depicts a side view of the clipper comb and heat resistant cover of FIG. 6;

FIG. 8 depicts a rear view of a clipper comb and heat resistant cover having an air channel therebetween;

FIG. 9 depicts a top view of the clipper comb and heat resistant cover of FIG. 8;

FIG. 10 depicts a top view of the clipper comb and heat resistant cover having a front vented section;

FIG. 11 depicts a side view of a clipper comb and heat resistant cover having an air channel therebetween;

FIG. 12 depicts a top view of the clipper comb and heat resistant cover of FIG. 11;

FIG. 13 depicts a side view of a clipper comb and heat resistant cover having alternative air channel therebetween;

FIG. 14 depicts a top view of the clipper comb and heat resistant cover of FIG. 13;

FIG. 15 depicts a top view of a clipper comb and heat resistant cover having a closed insulating air gap therebetween;

FIG. 16 depicts a front top isometric view of a clipper comb having a heat resistant cover including comb teeth;

FIG. 17 depicts a side vide of the clipper comb and heat resistant cover of FIG. 10;

FIG. 18 depicts a front isometric view of a clipper comb including vented sections;

FIG. 19 depicts a front isometric view of a clipper comb including alternative vented sections;

FIG. 20 depicts a top isometric view of a cutting blade of the present disclosure;

FIG. 21 depicts a side view of the cutting blade of FIG. 20;

FIG. 22 depicts a side view of another cutting blade of the present disclosure;

FIG. 23 depicts a side view of another cutting blade of the present disclosure;

FIG. 24 depicts a top view of a cutting blade of FIG. 20;

FIG. 25 depicts a top view of a cutting blade of the present disclosure; and

FIG. 26 depicts a top view of a cutting blade of the present disclosure.

### DETAILED DESCRIPTION OF THE INVENTION

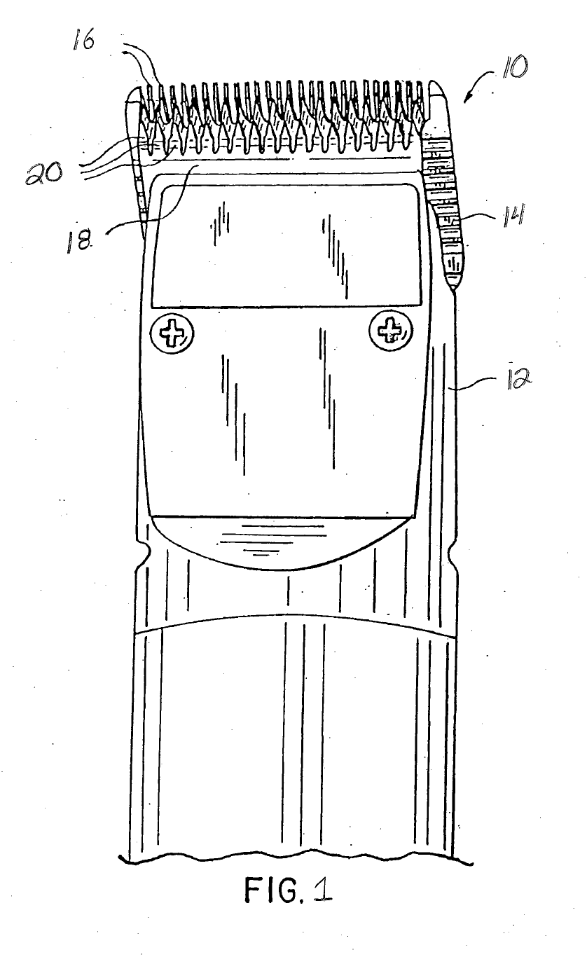

Referring now to the drawing figures in which like reference designators refer to like elements, there is shown in FIG. 1 a clipper blade set 10 constructed in accordance with the present disclosure and mounted on an electric hair clipper 12. The clipper blade set 10 has a clipper comb 14 having a plurality of comb teeth 16 that are run through hair like a comb and cut the hair when the electric hair clipper 12 is activated. Within the electric hair clipper 12 is an electric motor that drives a cutter blade 18 in a known fashion.

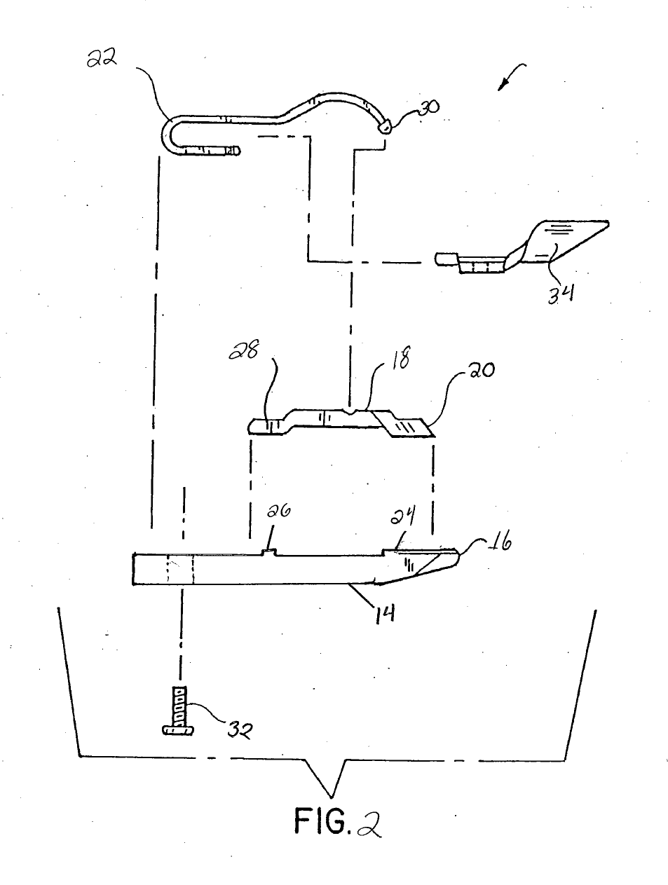

Referring to FIG. 2, there is shown an exploded side plan view of the clipper blade set 10 of FIG. 1. A cutter blade 18 is resiliently and slideably pressed against a stationary clipper comb 14 by a spring member 22. The cutter blade 18 contacts the clipper comb 14 along two rail-like surfaces 24, 26. A rear cutter blade rail 28 makes slideable contact with a slide rail 24 on the inner surface of the clipper comb 14, while the scissor teeth 20 of the cutter blade 18 are in slideable contact with the comb teeth 16 of the clipper comb 14.

The spring member 22 can exert several pounds of downward force upon the cutter blade 18. The spring member 22 may include a low friction blade guide 30 to reduce sliding friction with the cutter blade 18. The blade guide 30 can be made of a polymer material, such as a polytetraflouroethelene material or a nylon material. Particularly useful materials are molybdenum disulphide (MoS2) filled nylons.

The spring member 22 may be fixedly attached to a spring rail by any convenient attachment, such as one or more screws 32. Also shown is an attachment member 34, which may be fitted within the spring member 22 and attached to the clipper comb 12 along with the spring member 22 with the same set of screws 32. The attachment member 34 is shaped and designed in a conventional manner to allow the clipper blade assembly 10 to be mounted on the electric hair clipper 12 (FIG. 1).

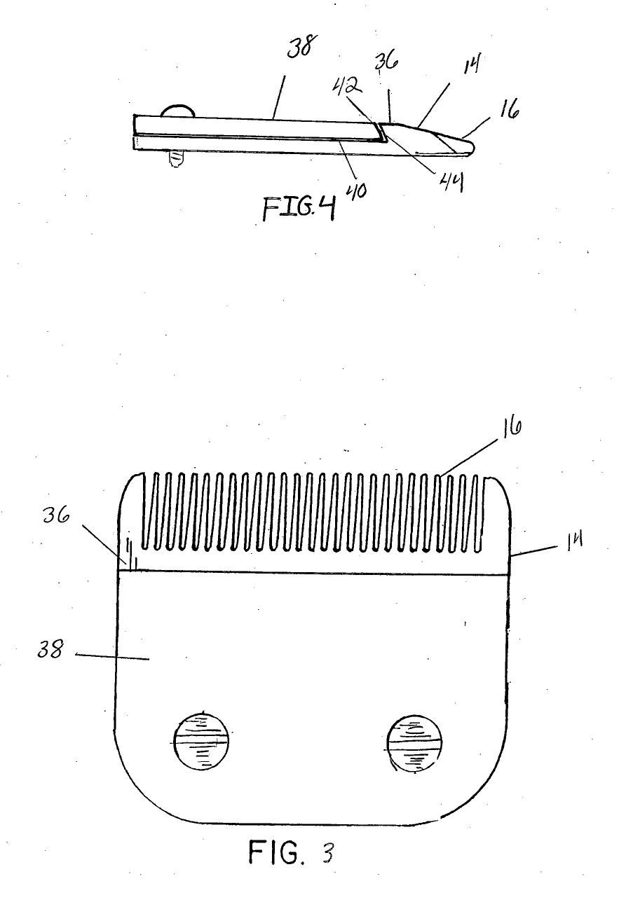

Referring to FIGS. 3 and 4, an outer surface 36 of the stationary clipper comb 14 can include a heat resistant cover 38. The heat resistant cover 38 reduces the transmission of heat from the clipper comb 14 to the scalp/skin of a user. The heat resistant cover 38 can be mounted to the clipper comb 14 with an adhesive fastener or mechanical fastener. The heat resistant cover 38 provides a protective, insulating, barrier between the clipper comb 14 and the skin of a user. The heat resistive cover 38 can be made of plastic or other known heat resistive material.

The outer surface 36 of the clipper comb 14 can include a rear notched surface 40, onto which the heat resistant cover 38 is mounted. In this manner, the heat resistant cover 38 can be mounted flush with the outer surface 36 of the clipper comb 14.

A front edge 42 of the heat resistant cover 38 can be provided at an angle, which can be positioned in a corresponding reverse angle of a front surface 44 of the notched section 40. In this manner, the front edge 42 of the heat resistant cover 38 can be secured to the clipper comb 14, substantially preventing a pulling-up of the front edge 42 of the heat resistant cover 38 when in use.

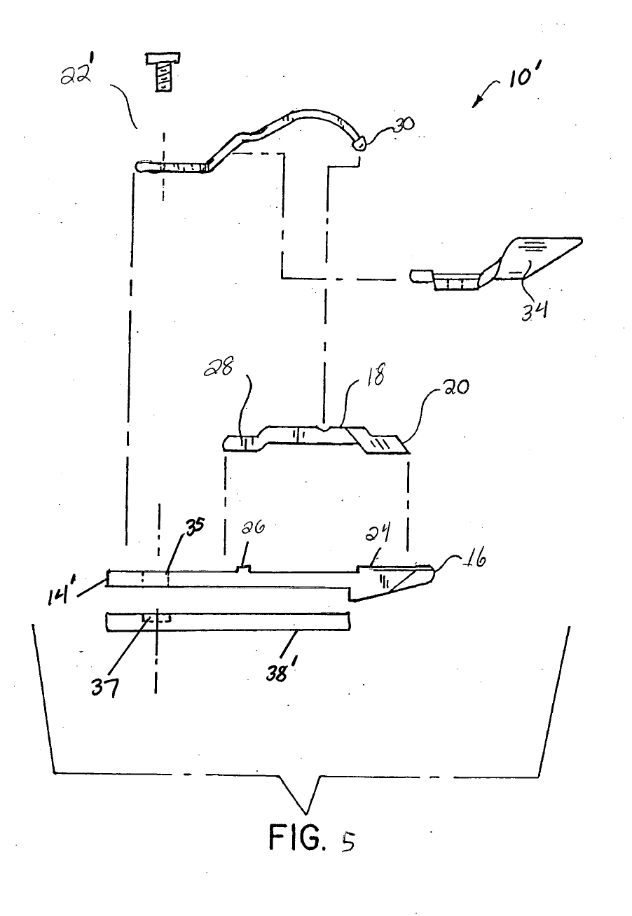

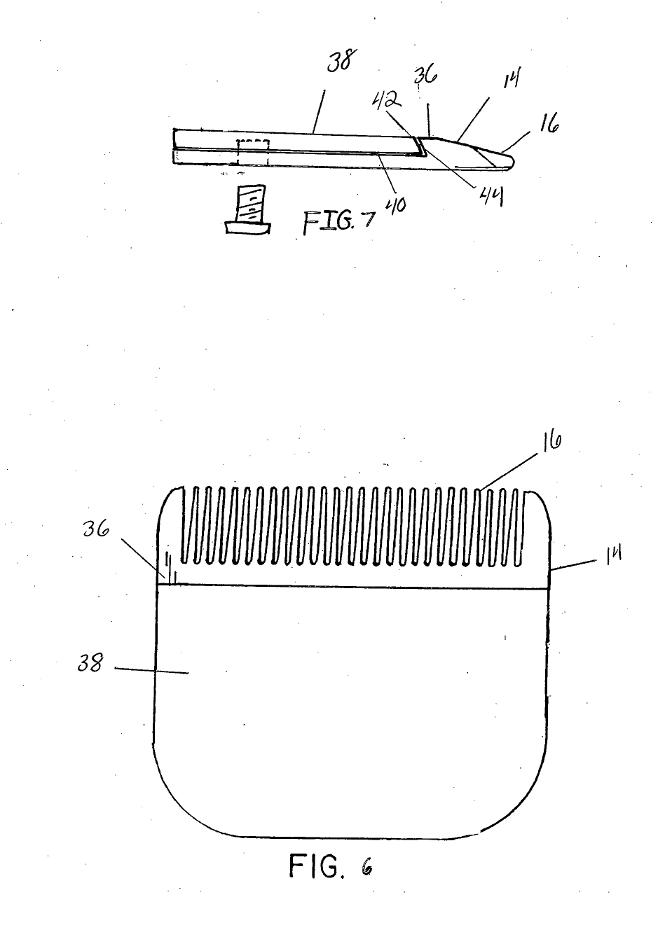

Referring to FIGS. 5-7, there is shown an exploded side plan view of the clipper blade set 10′. A cutter blade 18 is resiliently and slideably pressed against a stationary clipper comb 14 by a spring member 22. The cutter blade 18 contacts the clipper comb 14 along two rail-like surfaces 24, 26. A rear cutter blade rail 28 makes slideable contact with a slide rail 24 on the inner surface of the clipper comb 14′, while the scissor teeth 20 of the cutter blade 18 are in slideable contact with the comb teeth 16 of the clipper comb 14.

An outer surface 36 of the stationary clipper comb 14′ can include a heat resistant cover 38′. The heat resistant cover 38 reduces the transmission of heat from the clipper comb 14 to the scalp/skin of a user. The heat resistant cover 38′ can be mounted to the clipper comb 14′ with an adhesive fastener or mechanical fastener. The heat resistant cover 38 provides a protective, insulating, barrier between the clipper comb 14 and the skin of a user. The heat resistive cover 38′ can be made of plastic or other known heat resistive material.

The spring member 22′ can exert several pounds of downward force upon the cutter blade 18. The spring member 22 may include a low friction blade guide 30 to reduce sliding friction with the cutter blade 18. The blade guide 30 will be made of a polymer material, such as a polytetraflouroethelene material or a nylon material. Particularly useful materials are molybdenum disulphide (MoS2) filled nylons.

The spring member 22 may be fixedly attached to a spring rail by any convenient attachment, such as one or more screws 32. The screws 32 can be positioned through the spring member 22′ and the clipper comb 14′ engaging a boss 37 in the inner surface of the heat resistive cover 38′. In this manner, the screws 32 do not pass entirely through the heat resistive cover 38′. It is also envisioned that the holes 35 through the clipper comb 14′ can be threaded, such that the screws 32 engage the clipper comb 14′ as they pass through the holes 35 in the clipper comb 14′.

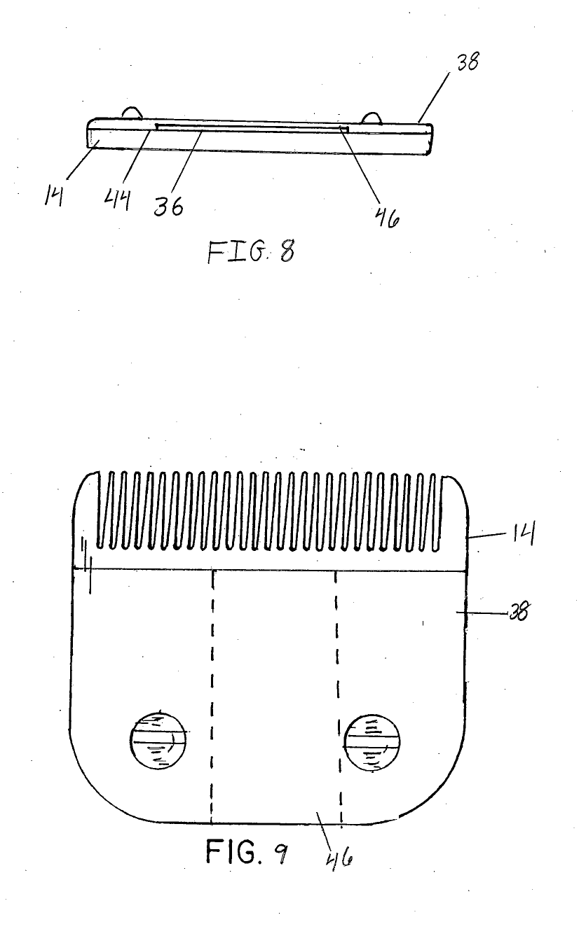

Referring to FIGS. 8 and 9, a bottom surface 46 of the heat resistant cover 38 can include an air channel 46, where the air channel 46 is positioned adjacent to the outer surface 36 of the clipper comb 14. The air channel 46 allows for the flow of air between the clipper comb 14 and the heat resistant cover 38 to decrease the transmission of heat from the clipper comb 14. As shown in FIG. 8, the air channel 46 is provided along at least a portion of the longitudinal length of the clipper comb 14.

Referring to FIG. 10, a front edge 47 of the heat resistant cover 38 can include a vented section 49. The vented section 49 can be substantially aligned with the air channel 46, such that an air flow path is provided between the heat resistant cover 38 and the clipper comb 14.

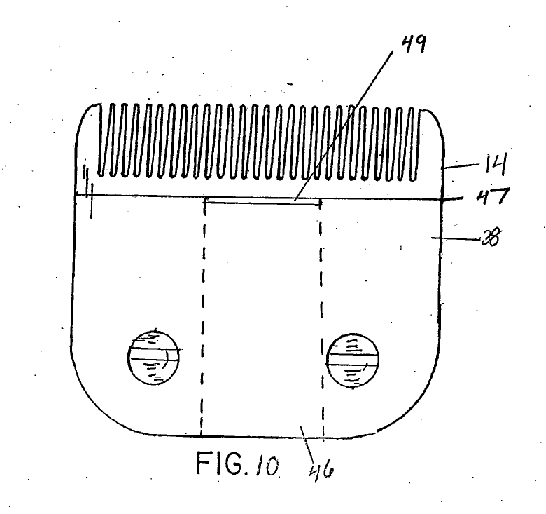

Referring to FIGS. 11 and 12, the bottom surface 46 of the heat resistant cover 38 can include a lateral air channel 48, where the lateral air channel 48 is positioned adjacent the outer surface 36 of the clipper comb 14. The lateral air channel 48 allows for the flow of air between the clipper comb 14 and the heat resistant 38 cover to decrease the transmission of heat from the clipper comb 14. The lateral air channel 48 is provided along the lateral length of the clipper comb 14.

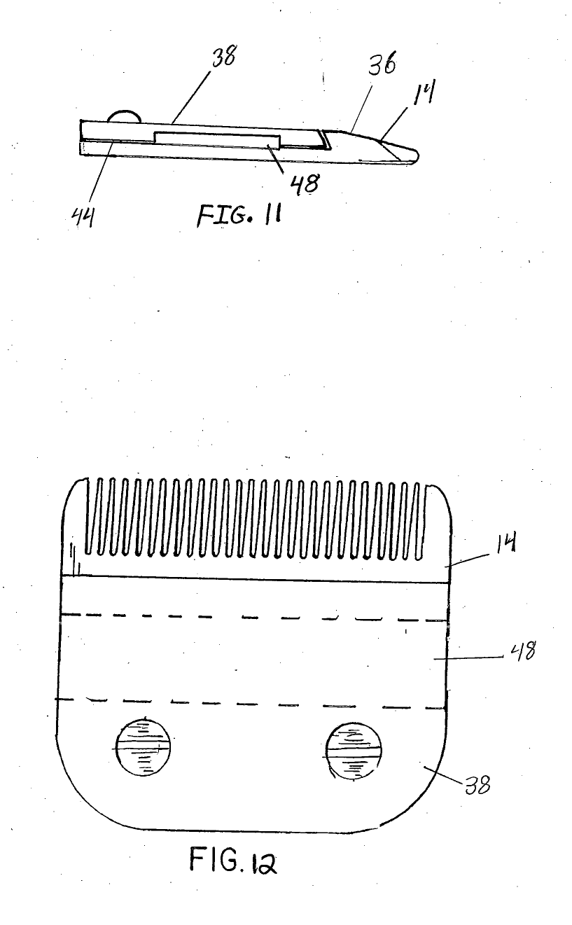

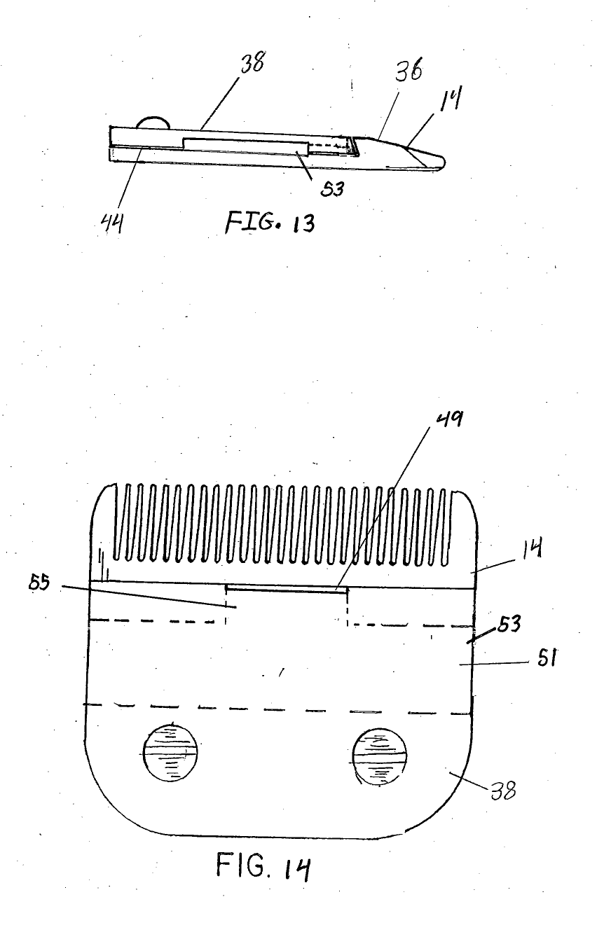

Referring to FIGS. 13 and 14, the bottom surface 46 of the heat resistant cover 38 can include a substantially T-shaped air channel 51. The T-shaped air channel 51 includes a lateral section 53 extending through the width of the heat resistant cover 38 and a longitudinal section 55 extending a least partially along the length of the heat resistant cover 38, where the T-shaped air channel 51 is positioned adjacent the outer surface 36 of the clipper comb 14. The T-shaped air channel 51 allows for the flow of air between the clipper comb 14 and the heat resistant 38 cover to decrease the transmission of heat from the clipper comb 14.

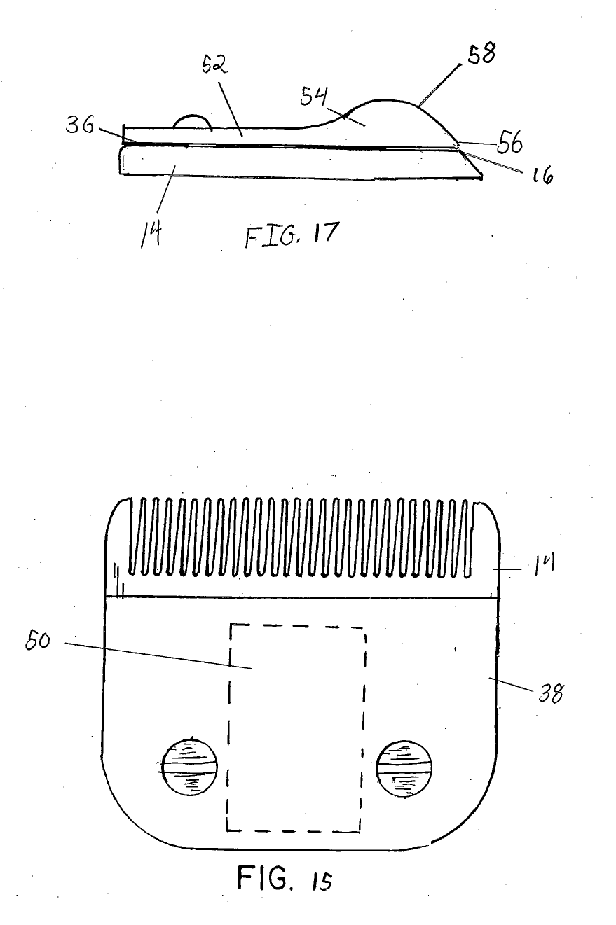

Referring to FIG. 15 the heat resistant cover 38 can include an indented section 50 on the inner surface 40. In this configuration, when mounted to the clipper comb 14, the indented section 50 provides an air gap between the inner surface 40 of the heat resistant cover 38 and the outer surface 36 of the clipper comb 14. The air located within the air gap provides an insulation barrier, decreasing the transmission of heat between the clipper comb 14 and the heat resistant cover 38.

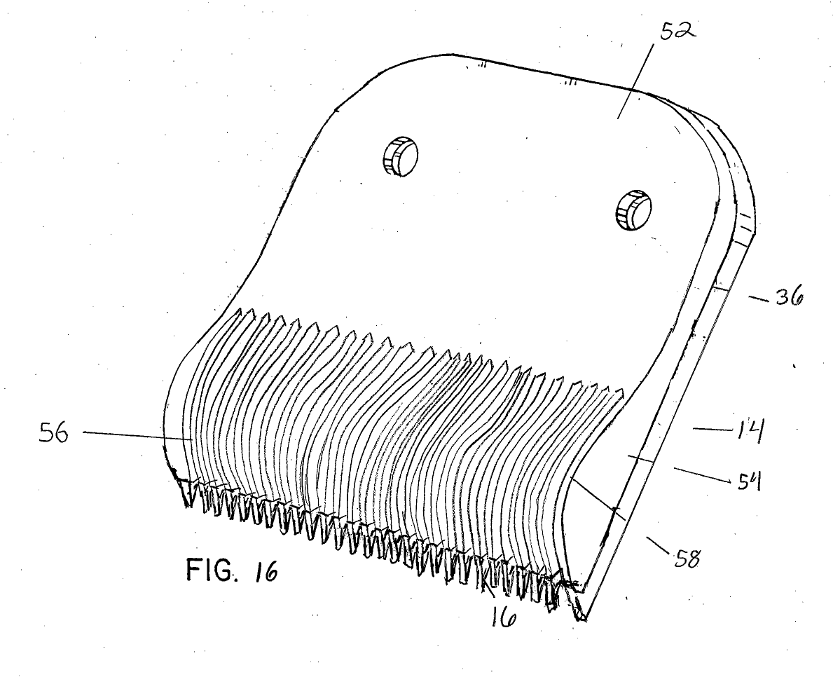

Referring to FIG. 16, a heat resistant cover 52 is provided which substantially covers the outer surface 36 of the clipper comb 14. A front portion 54 of the heat resistant cover 52 can include comb teeth 56, which are substantially aligned with the teeth 16 of the clipper comb 14.

Referring also to FIG. 17, the front portion 54 of the heat resistant cover 52 can include a raised arcuate section 58. The radius of curvature of the raised arcuate section can be selected such that the clipper comb 14 and heat resistant cover 52 combination combine to form a designated sized clipper blade set 10, for example #1, #2, #3, #4, etc. Alternatively, for an adjustable size clipper blade set 10, the radius of curvature of the raised arcuate section can be selected such that the clipper comb 14 and heat resistant cover 52 combination combine to form a designated range of sizes.

Referring to FIG. 18, a stationary clipper comb 60 is provided having a plurality of vented sections 62 through the clipper comb 60. When used in combination with the cutter blade 18, air is forced through the vented sections 62 allowing for convective cooling of the clipper comb 60. The vented sections 62 can account for a sufficient surface area of the clipper comb 60, while maintaining the structural integrity of the clipper comb 60. For example, the vented sections 62 can account for between 0% and 75% of the surface area of the clipper comb 60.

The vented sections 62 can be provided as longitudinal slots extending along the longitudinally length of the clipper comb 60. Alternatively, not shown, the vented sections 62 can be provided as lateral slots extending along the lateral width of the clipper comb 60.

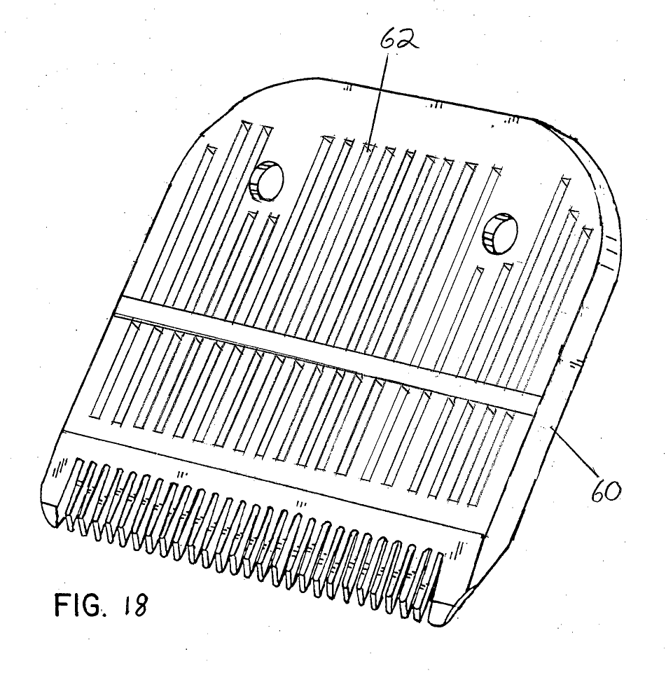

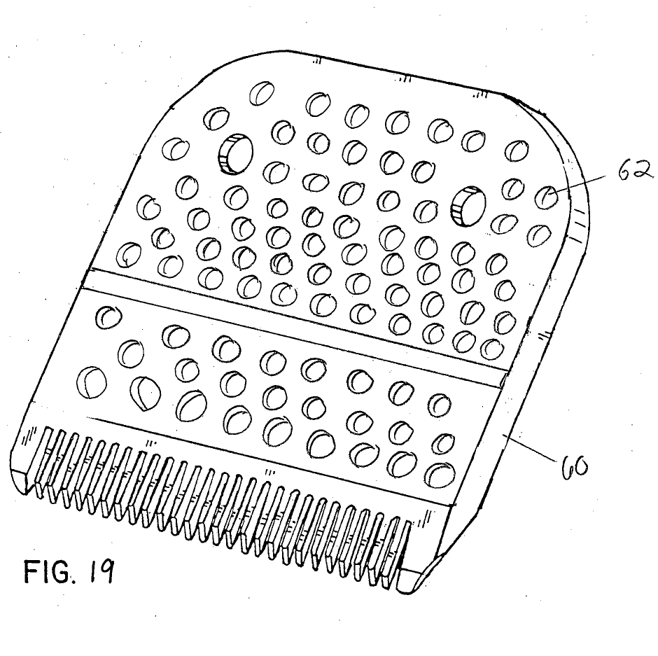

Referring to FIG. 19, the vented sections 62 can be provided a plurality of geometric channels through the clipper comb. For example, the geometrical shape of the vented sections 62 can be circular, elliptical, rectangular, triangular, and any similar geometric shape.

The vented clipper comb 60, as depicted in FIGS. 18 and 19, can be used in conjunction with the above heat resistant covers 38 and 52. In such use, clipper combs 14 and 14′ can be modified to include the vented configurations of clipper comb 60. The cover 52 can includes vented sections along the front portion 54 of the cover 52, aligned with the air channel provide therein providing a flow path.

Referring to FIG. 20, a cutting blade 64 of the present invention is provided. The cutting blade 64 includes a plurality of fins 66 extending from the inner surface 68 of the cutting blade 64. When used in combination with a clipper comb, the fins 66 force air along the surface of the clipper comb, allowing for convective cooling of the clipper comb.

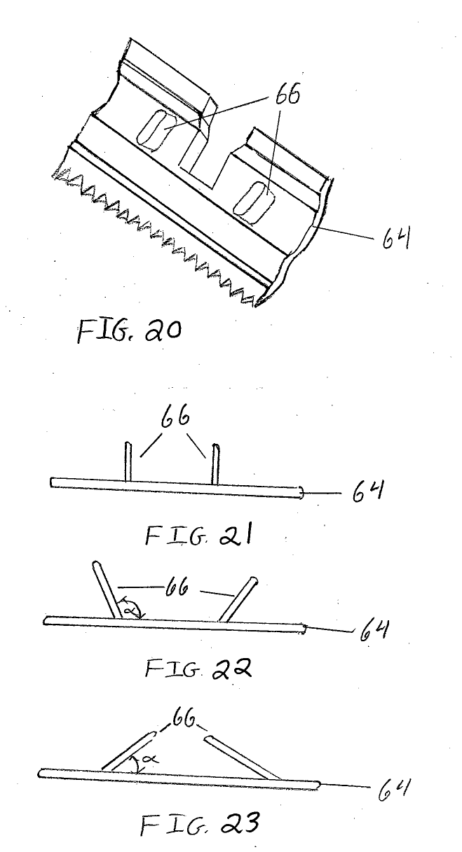

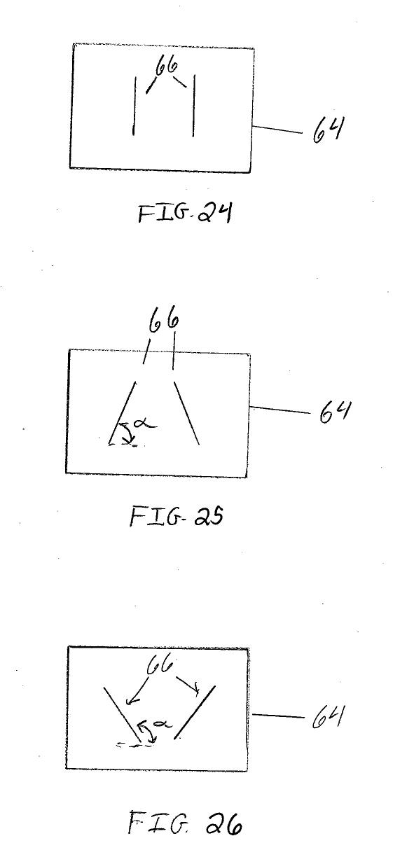

For example, when the cutting blade 64 is used in combination with clipper comb 60, the fins 66 force air through the vented sections 62 allowing for convective cooling of the clipper comb 60. Referring to FIGS. 21-23, the fins 66 can extend at acute, obtuse, or perpendicular angles from the inner surface 68 of the cutting blade 64. Referring to FIG. 24-26, the fins can be provided at acute, obtuse, or parallel angles to each other along the length of the cutting blade 64.

FIGS. 20-26 depict two fins 66 on the inner surface 66 of the cutting blade 64. However, it is envisioned that one or more fin 66 can be provided on the inner surface 66 of the cutting blade 64 in a variety of the above configurations, each having the same or different angles with respect to the inner surface 66 of the cutting blade 64 and each other. Furthermore, each of the cutting blades 64 can have differing lengths, and be provided in an offset configuration, laterally or longitudinal, along the inner surface 66 of the cutting blade 64.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A stationary clipper comb comprising;
an inner surface;
an outer surface; and
a cover affixed to the outer surface, wherein the cover includes an air channel provided between an inner surface of the cover and the outer surface of the stationary clipper comb.

2. A stationary clipper comb as set forth in claim 1, wherein the air channel extends longitudinal along the inner surface of the cover.

3. A stationary clipper comb as set forth in claim 1, wherein the air channel extends laterally along the inner surface of the cover.

4. A stationary clipper comb as set forth in claim 1, wherein the air channel extends laterally along the inner surface of the cover and at least partially longitudinally along the inner surface of the cover.

5. A stationary clipper comb as set forth in claim 1, wherein a front edge of the cover includes a vented section in fluid communication with the air channel.

6. A stationary clipper comb as set forth in claim 1, further comprising a plurality of vented sections extending through the inner and outer surfaces of the stationary clipper comb.

7. A stationary clipper comb as set forth in claim 6, wherein the plurality of vented sections have substantially rectangular cross-section.

8. A stationary clipper comb as set forth in claim 7, wherein the plurality of vented sections extend in a longitudinal direction along the stationary clipper comb.

9. A stationary clipper comb as set forth in claim 7, wherein the plurality of vented sections extend in a lateral direction along the stationary clipper comb.

10. A stationary clipper comb as set forth in claim 6, wherein the plurality of vented sections are substantially circular cross section.

11. A blade set for use with a hair clipper/trimmer comprising:
a stationary clipper comb having an inner surface and an outer surface;
a cutter blade movably coupled to the inner surface of the stationary comb; and
a cover affixed to the outer surface of the stationary comb, wherein an air channel is provided along an inner surface of cover proving an air path between the inner surface of the cover the outer surface of the stationary comb.

12. A blade set for use with a hair clipper/trimmer as set forth in claim 11, wherein the stationary comb includes a plurality of vented sections extending through the inner and outer surfaces of the stationary comb.

13. A blade set for use with a hair clipper/trimmer as set forth in claim 11, wherein the air channel extends longitudinal along the inner surface of the cover.

14. A blade set for use with a hair clipper/trimmer as set forth in claim 11, wherein the air channel extends laterally along the inner surface of the cover.

15. A blade set for use with a hair clipper/trimmer as set forth in claim 11, wherein the air channel extends laterally along the inner surface of the cover and at least partially longitudinally along the inner surface of the cover.

16. A blade set for use with a hair clipper/trimmer as set forth in claim 11, wherein the cutter blade includes at least one fin.
